(19) United States
(12) Patent Application Publication
(10) Pub. No.: US 2012/0012581 A1
(43) Pub. Date: Jan. 19, 2012

(54) Carton and Carton Blank

(75) Inventors: Kyle Schumaker, Richmond, VA (US); Bradford J. Walling, Chesterfield, VA (US)

(73) Assignee: MEADWESTVACO PACKAGING SYSTEMS, LLC, Richmond, VA (US)

(21) Appl. No.: 13/186,396

(22) Filed: Jul. 19, 2011

Related U.S. Application Data
(60) Provisional application No. 61/365,472, filed on Jul. 19, 2010.

(51) Int. Cl. B65D 6/00; F16B 17/00

(52) U.S. Cl. 220/6; 403/382

(57) ABSTRACT

A locking mechanism for locking first and second panels of a carton together includes first and second male tabs hinged along first and second fold lines respectively to the first panel. The male tabs are arranged so as to oppose one another. The mechanism also includes first and second female tabs hinged along third and fourth fold lines respectively to the second panel. The female tabs are arranged so as to oppose one another. The first and second fold lines are substantially perpendicular to the third and fourth fold lines when the first and second panels are disposed in an overlapping relationship. In a locked position, the male tabs are displaced from the plane of the first panel and pass through an aperture formed in the second panel by displacement of the female tabs. Each male tab is displaced out of the plane of the first panel by an angle greater than 90° and being maintained in position by respective side edges of the female tabs.

### CROSS REFERENCE TO RELATED APPLICATION

This application claims priority to U.S. Provisional Application No. 61/365,472, filed Jul. 19, 2010, the entirety of which is incorporated herein by reference.

### FIELD OF INVENTION

The present invention relates to a carton and blank for forming the same, more specifically, but not exclusively to a carton having a locking mechanism for locking a pair of panels together.

### BACKGROUND OF THE INVENTION

In the field of packaging it is often required to provide consumers with a package comprising multiple primary product containers, such multi-packs are desirable for shipping and distribution and for display of promotional information. For cost and environmental considerations such cartons or carriers need to be formed from as little material as possible and cause as little wastage in the material from which they are formed as possible. Another consideration is the strength of the packaging and its suitability for holding and transporting large weights of articles.

It is known to interlock a pair of panels together using locking tabs which are struck from one panel (for example one end of a carton wrapper). The locking tabs are arranged to be driven or punched through corresponding apertures, defined by retaining tabs, struck from another panel (for example the opposite end of a carton wrapper). Such “punch-locks” are known and are illustrated, for example, in U.S. Pat. No. 4,093,116 and U.S. Pat. No. 5,131,588.

It is desirable, for cost saving and environmental reasons to use lighter weight material, particularly for paperboard and plastics packaging and to have more flexibility in terms of the positioning of the locking mechanisms. It is for these and other reasons that the present invention seeks to provide an improvement in the field of panel interlocking mechanisms.

It is also desirable to provide a reliable locking mechanism which can lock two panels together. It is preferable if the locking mechanism can be operated by packaging machinery to increase speed of production.

### SUMMARY OF INVENTION

The present invention seeks to overcome or at least mitigate the problems of the prior art.

According to a first aspect of the present invention, there is provided a locking mechanism for locking a pair of panels of a carton together. The mechanism includes: first and second male tabs hinged along first and second fold lines respectively to a first panel wherein the male tabs are arranged so as to oppose one another; and first and second female tabs hinged along third and fourth fold lines respectively to a second panel wherein the female tabs are arranged so as to oppose one another. The first and second fold lines are substantially perpendicular to the third and fourth fold lines when the first and second panels are disposed in an overlapping relationship wherein in a locked position the male tabs are displaced from the plane of the first panel and pass through an aperture formed in the second panel by displacement of the female tabs. In the locked position, the male tabs are displaced out of the plane of first panel by an angle greater than 90° and being maintained in the locked position by side edges of the female tabs.

Preferably, the male and/or female tabs are substantially rectangular, square or trapezoidal in shape.

Preferably, the female tabs are wider than the male tabs such that the third and fourth fold lines are longer that the first and second fold lines.

Preferably, in a flat undisplaced position, the male tabs share a common line of severance defining the respective free edges of the male tabs, the common line opposing the first and second fold lines.

Preferably, at least one of the first, second, third or fourth fold lines is defined, at least in part, by an embossed line or score line. The embossed or score line are longer or shorter than the fold line.

Preferably, the side edges of each of the female tabs are be arcuate in shape.

Preferably, the female tabs are tapered so as to be narrower at the free end edge than at the proximal end edge.

Preferably, in a flat undisplaced position, the female tabs share a common line of severance.

According to a second aspect of the present invention, there is provided a package including a carton and at least four articles received in the carton. The articles are arranged in at least two rows of two articles each so as to create a void between the at least four articles. The carton includes a first panel and a second panel in at least partially overlapping relationship with one another. The overlapping region of the first and second panels is aligned with the void between the at least four articles. The overlapping region of the first panel includes a pair of male tabs of a first locking mechanism and a pair of male tabs of a second locking mechanism. The overlapping region of the second panel includes a pair of female tabs of the first locking mechanism and a pair of female tabs of the second locking mechanism. The male tabs of the first locking mechanism are received in an aperture defined in the second panel by displacement of the female tabs of the first locking mechanism while the male tabs of the second locking mechanism are received in an aperture defined in the second panel by displacement of the female tabs of the second locking mechanism such that the male and female tabs of the first and second locking mechanism are disposed in the void between the at least four apertures.

Preferably, the fold lines between the male tabs of the first locking mechanism and the first panel are arranged to be substantially perpendicular to the fold lines between male tabs of the second locking mechanism and the first panel.

Preferably, the fold lines between the female tabs of the first locking mechanism and the second panel are arranged to be substantially perpendicular to the fold lines between the female tabs of the second locking mechanism and the second panel.

Preferably, the male tabs of the first and second locking mechanism are each coupled to the first panel by a fold line wherein each of the first fold lines is orientated at an angle to a free edge of the first panel.

Preferably, the female tabs of the first and second locking mechanism are each coupled to the second panel by a second fold line, wherein each of the second fold lines is orientated at an angle to a free edge of the second panel.

Preferably, the angle between each first fold line and the free edge of the first panel is approximately 45°.

Preferably, the angle between each second fold lines and the free edge of the second panel is approximately 45°.

Preferably, the articles are generally cylindrical.

Preferably, the articles are generally circular in cross section at one end adjacent to the first and second panels.

### BRIEF DESCRIPTION OF THE DRAWINGS

Exemplary embodiments of the invention will now be described with reference to the accompanying drawings, in which:

FIG. 1 is a plan view from above of a blank for forming a carton according to a first embodiment of the invention;

FIG. 2 is an enlarged plan view from above of the locking mechanism according to a first embodiment of the present invention;

FIG. 3a is an enlarged plan view from above of a female element locking mechanism according to a first embodiment of the present invention;

FIG. 3b is an enlarged further plan view from above of a male element locking mechanism according to a first embodiment of the present invention;

FIG. 4 is a perspective view from above of an internal portion of a carton according to a first embodiment of the present invention;

FIG. 5 is a perspective view from above of a carton formed from the blank of FIG. 1;

FIG. 6A is a enlarged view of the locking mechanism according to a first embodiment of the present invention formed; and

FIG. 6B is a view taken along the line X-X in FIG. 6A.

### DETAILED DESCRIPTION OF EXEMPLARY EMBODIMENTS OF THE PRESENT INVENTION

Detailed descriptions of specific embodiments of the package, blanks and cartons are disclosed herein. It will be understood that the disclosed embodiments are merely examples of the way in which certain aspects of the invention can be implemented and do not represent an exhaustive list of all of the ways the invention may be embodied. Indeed, it will be understood that the packages, blanks and cartons described herein may be embodied in various and alternative forms. The figures are not necessarily to scale and some features may be exaggerated or minimized to show details of particular components. Well-known components, material or methods are not necessarily described in great detail in order to avoid obscuring the present disclosure. Any specific structural and functional details disclosed herein are not to be interpreted as limiting, but merely as a basis for the claims and as a representative basis for teaching one skilled in the art to variously employ the invention.

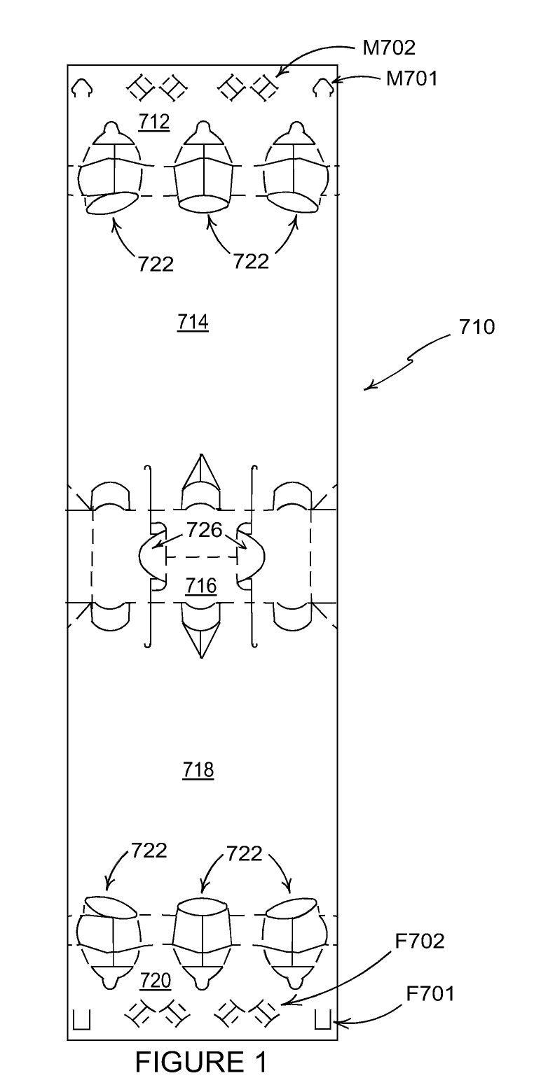

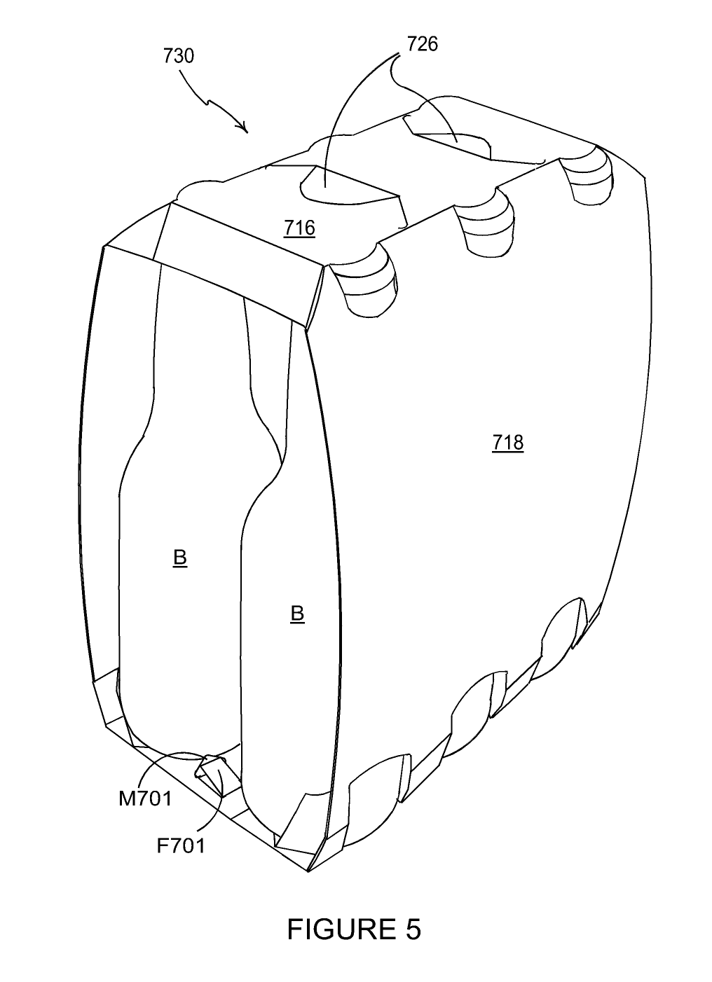

Turning now to FIG. 1, there is shown a blank 710 of foldable sheet material, such as paperboard or plastics, for forming a wraparound style carton 730 illustrated in FIG. 5. The blank 710 is sized, shaped and configured to securely hold six bottles herein after applied onto articles B, in a 2×3 configuration. In alternative embodiment, articles of other configurations may be retained. It will be understood from reading the foregoing description that the panel interlocking means IM9 described could be utilized in a number of applications. The panel interlocking means IM9 has a beneficial application in the field of packaging, however the style of packaging, materials from which the packaging are formed, articles B to be packaged and number of articles B packaged may be selected from many various options and as such the blank 710 and carton 730 formed therefrom represent only one of many different ways in which the invention can be put into effect.

The blank 710 comprises a plurality of panels arranged in series and hinged one to the next including: a first bottom panel 712, a first side panel 714, a top panel 716, a second side panel 718 and a second bottom panel 720. The blank 710 further comprises a number of entirely optional features for securing the articles B within the carton 730 once formed, these include: heel locking apertures 722, tear access opening means 728, bottle top securing apertures 724 and handling means 726. These features do not form part of the invention and are not further described.

The first and second bottom panels 712, 720 of the blank 710 are provided with panel interlocking means IM9 according to a first embodiment of the invention.

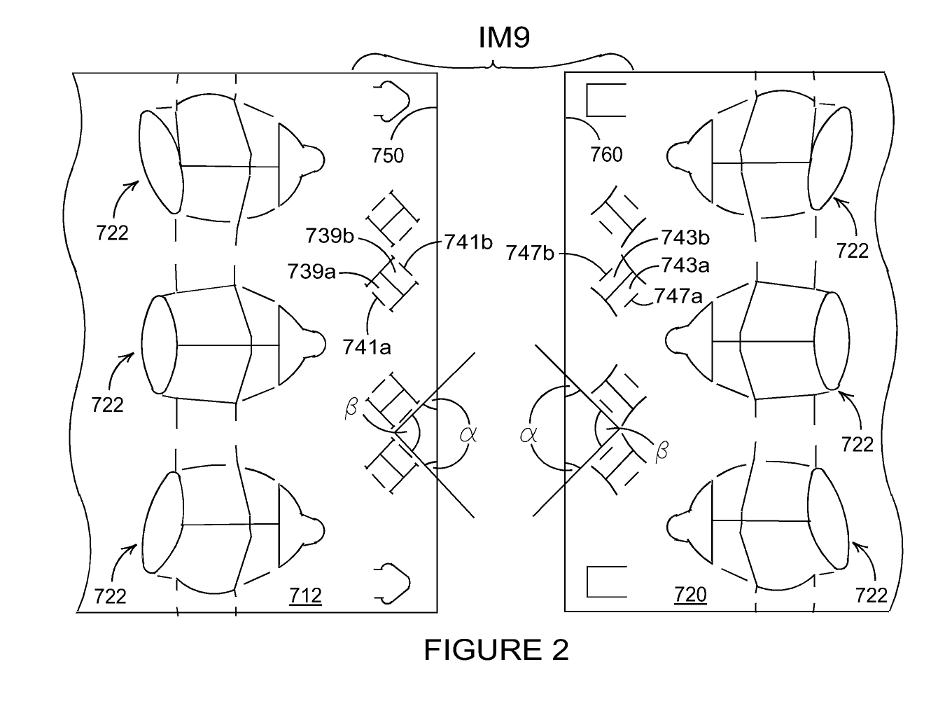

FIG. 2 illustrates the panel interlocking means IM9 in further detail. The panel interlocking means IM9 comprises a first punch lock having male element M701 which mates with female element F301. Female element F701 comprises a substantially rectangular shaped tab defined at least in part by a “U” shaped line of severance. Male element M701 comprises an arrowhead shaped tab which arrowhead points toward the free end edge of the first bottom panel 712.

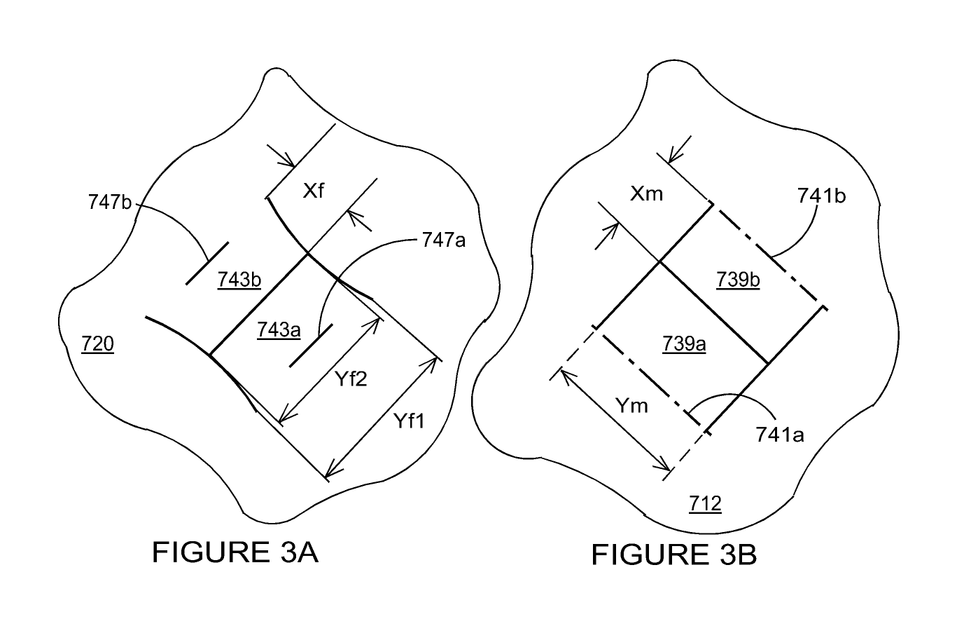

The panel interlocking means IM9 also comprises a second punch lock according to a first embodiment of the present invention; the punch lock comprises a male element M702 and a female element F702. The female element F702 is illustrated in greater detail in FIG. 3a and comprises a pair of female tabs 743a, 743b which are rectangular or substantially trapezoidal in shape, which are defined, at least in part, by a “H” shaped line of severance. The pair of female tabs 743a, 743b each comprises a hinged connection 747a, 747b to the second base panel 720.

Preferably, the side edges of each of the female tabs 743a, 743b are accurately shaped. The female tabs 743a, 743b have a length Xf.

Preferably, the female tabs 743a, 743b are tapered in shape such that they have a width Yf1 at the point of the hinged connection to the second base panel 720 and have a width Yf2 at a free end edge wherein the width Yf2 is preferably less than the width Yf1.

The male element M302 is illustrated in FIG. 3B and comprises a pair of male tabs 739a, 739b which are defined in part by an “H” shaped line of severance. Each of the male tabs 739a, 739b is hinged to the first base panel 712 along fold lines 741a, 741b. Preferably the male tabs 739a, 739b are rectangular in shape and have a length Xm and a width Ym. In the preferred embodiment the length Xm of the male tabs 739a, 739b is greater than the Xf of the female tabs 747a, 747b. Referring to FIGS. 3A and 3B the width Yf1 and/or the width Yf2 of the female tabs 743a, 743b is greater than the width Ym of the male tabs 739a, 739b. In the case when the width Yf1 of the female tabs 743a, 743b is greater than the width Ym of the male tabs 739a, 739b the hinged connections 747a, 747b are longer than the fold lines 741a, 741b.

In the preferred embodiment the hinged connection 741a, 741b of the male tabs 739a, 739b to the first base panel 712 is defined at least in part by an embossed line or score line, preferably the embossed line is longer than the hinged connection 747a, 747b and hence the width Ym of the male tabs 739a, 739b.

The hinged connection 747a, 747b between the female tabs 743a, 743b and the second base panel 720 are also defined, at least in part, by an embossed line or score line, preferably the score line is shorter than the hinged connection 747a, 747b and hence the width Yf1 of the female tabs 739a, 739b.

Referring to FIG. 2, it can be seen that the male and female tabs 739a, 739b, 743a, 743b are disposed at an angle α to a free end edge 750, 760 of the respective first and second base panels 712, 720. Preferably the angle α is 45°.

In the preferred embodiment a pair of locking means are arranged adjacent one another and at an angle β to one another preferably the pair of locking means are disposed perpendicularly with respect to one another, and more preferably arranged such that both of the locking means are provided within an area of the respective base panel 712, 720 which is defined, in part, by a pair of adjacent article receiving means 722.

In a set up package a pair of locking means are positioned in registry with a void defined between two adjacent articles in a first row of articles B and two adjacent articles B in a second row of articles B.

Turning to the construction of the carton 730, it is envisaged that the carton 730 can be formed by a series of sequential folding operations in a straight line machine so that the carton 730 is not required to be rotated or inverted to complete its construction. The folding process is not limited to that described below and may be altered according to particular manufacturing requirements.

The carton 730 is formed by wrapping the blank 710 of FIG. 1 about a group of articles B and engaging the male elements M701, M702 of the panel interlocking means IM9 with the female elements F701, F702 to form a carton 730 as shown in FIG. 5.

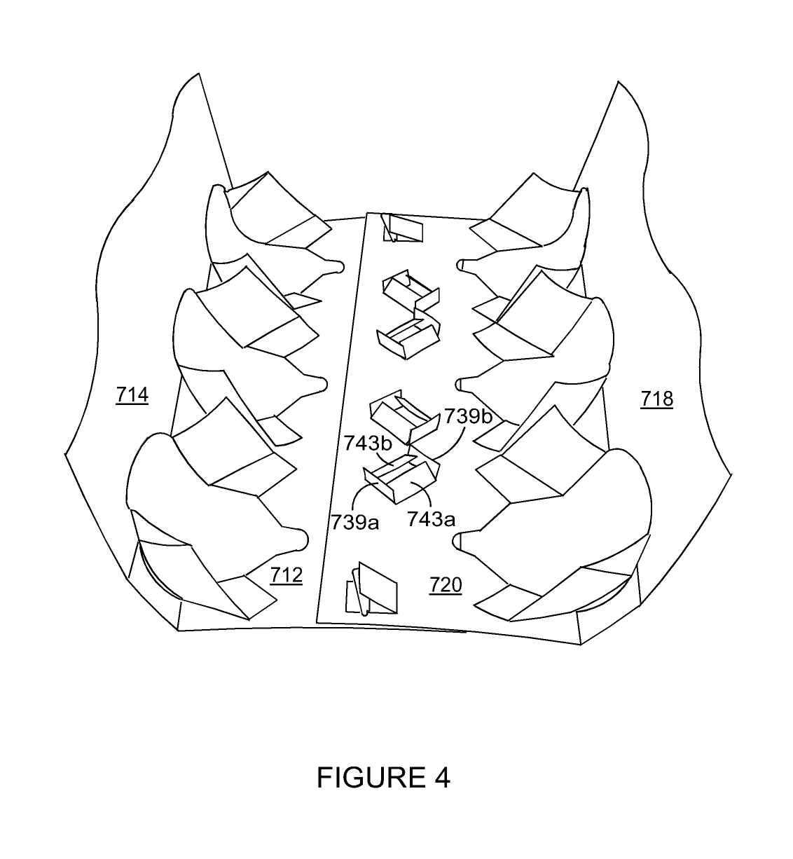

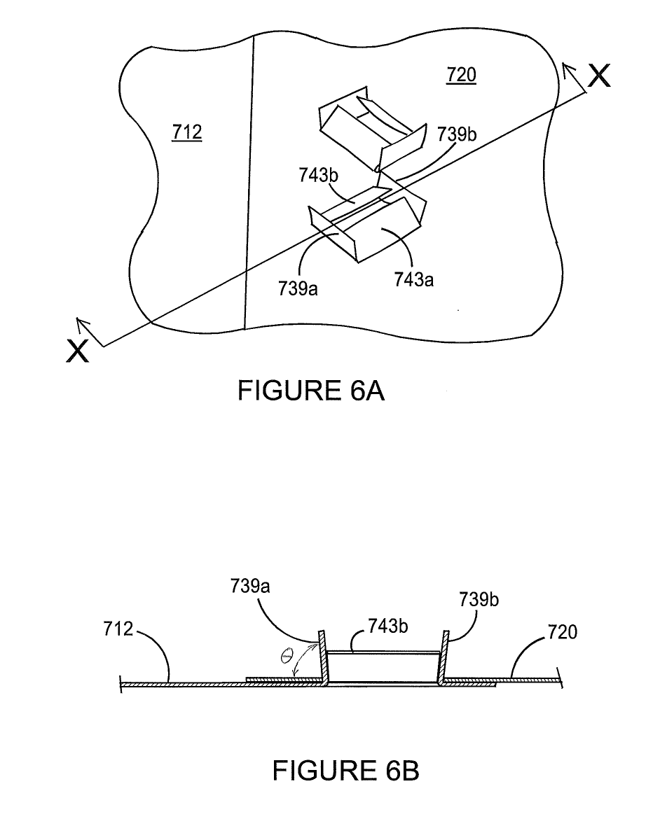

FIG. 4 shows an internal portion of the base of a carton 730 formed from the blank 710 of FIG. 1 the articles B have been removed for illustrative purposes. FIG. 6A illustrates a close up view of the locking mechanism in a deployed position, FIG. 6B is a side view of the locking mechanism of FIG. 6A when viewed along the line X-X in the direction indicated.

The second base panel 720 has been folded internally of the first base panel 712 in an overlapping relationship thereto.

The male and female elements M701, M702, F701, F702 of the panel interlocking means IM9 are in registry with one another. The male tabs 739a, 739b have been folded out of the plane of the first base panel 712 and inserted through the second base panel 720, through an aperture in the second base panel 720 formed by folding the female tabs 743a, 743b out of the plane of the second base panel 720.

The female tabs 743a, 743b have been arranged so that side edges of the female tabs 743a, 743b engage with an external face of the male tabs 739a, 739b such that the male tabs 739a, 739b are maintained in a folded position preferably, folded so as to form an arcuate angle θ between an internal face of the male tabs 739a, 739b and an internal face of the second base panel 720 (see FIG. 6B). In other words the male tabs 739a, 739b are folded out of the plane of the first base panel 712 by more than 90° and are maintained in that position by the female tabs 743a, 743b as best illustrated in FIG. 6B. The arcuate nature of the side edges of the aperture formed in the second base 720 panel acts upon the male tabs 739a, 739b causing them to bend about the side edges of the aperture.

The tapered shape of the female tabs 743a, 743b acts upon the male tabs 739a, 739b so that the female tabs 743a, 743b and the second base panel 720 tighten about the male tabs 739a, 739b, gripping the male tabs 739a, 739b between the edge of the aperture in the second base panel 720 and the side edge of the female tabs 743a, 743b. It is envisaged this occurs naturally due to the inherent resilient quality of the material the carton 730 is constructed from, the female tabs 743a, 743b will be resiliently biased to return to the plane of the second base panel 720. It is envisaged that by providing an embossed line or score line only partially along the length of the hinged connection between the female tabs 743a, 743b and the second base panel 720 more of the natural resilience of the material will be retained.

It can be appreciated that various changes may be made within the scope of the present invention, for example, the size and shape of the panels and apertures may be adjusted to accommodate articles of differing types, size or shape. In other embodiments of the invention it is envisaged that rather than being defined by an “H” shaped line of severance the male and/or female tabs may be separated from one another by an aperture.

It will be recognized that as used herein, directional references such as “top”, “bottom”, “front”, “back”, “end”, “side”, “inner”, “outer”, “upper” and “lower” do not limit the respective panels to such orientation, but merely serve to distinguish these panels from one another. Any reference to hinged connection should not be construed as necessarily referring to a single fold line only; indeed it is envisaged that hinged connection can be formed from one or more of the following, a short slit, a frangible line or a fold line without departing from the scope of the invention.

1. A locking mechanism for locking a pair of panels of a carton together, comprising;
first and second male tabs hinged along first and second fold lines respectively to a first panel wherein the first and second male tabs are arranged so as to oppose one another; and
first and second female tabs hinged along third and fourth fold lines respectively to a second panel wherein the first and second female tabs are arranged so as to oppose one another, wherein the first and second fold lines are substantially perpendicular to the third and fourth fold lines when the first and second panels are disposed in an overlapping relationship;
wherein in a locked position, the male tabs are displaced from the plane of the first panel and pass through an aperture defined in the second panel by displacement of the female tabs, and
wherein each of the male tabs is displaced out of the plane of the first panel by an angle greater than 90° and being maintained in the locked position by respective side edges of the female tabs.

2. A locking mechanism according to claim 1 wherein at least one of the male and female tabs has a shape selected from the group consisting of a substantial rectangle, square or trapezoid.

3. A locking mechanism according to claim 1 wherein the female tabs are wider than the male tabs such that the third and fourth fold lines are longer than the first and second fold lines.

4. A locking mechanism according to claim 1 wherein in an undisplaced position, the male tabs share a common line of severance defining respective free edges of the male tabs, the common line being disposed opposing the first and second fold lines.

5. A locking mechanism according to claim 1 wherein at least one of the first, second, third or fourth fold lines is defined, at least in part, by an embossed line or score line, the embossed line being unequal in length to a width of a respective one of the male and female tabs.

6. A locking mechanism according to claim 1 wherein the side edges of each of the female tabs are arcuate in shape.

7. A locking mechanism according to claim 1 wherein the female tabs are tapered so as to be narrower at a free end thereof than a proximal end thereof.

8. A locking mechanism according to claim 1 wherein in undisplaced position, the female tabs share a common line of severance.

9. A package comprising a carton and at least four articles received in the carton, the articles being arranged in at least two rows of two articles each so as to create a void between the at least four articles;
the carton comprising a first panel and a second panel in at least partially overlapping relationship with one another wherein the overlapping region of the first and second panels is aligned with the void between the at least four articles;
the overlapping region of the first panel comprising a pair of male tabs of a first locking mechanism and a pair of male tabs of a second locking mechanism, the overlapping region of the second panel comprising a pair of female tabs of the first locking mechanism and a pair of female tabs of the second locking mechanism wherein the male tabs of the first locking mechanism are received in an aperture formed in the second panel by displacement of the female tabs of the first locking mechanism and the male tabs of the second locking mechanism are received in an aperture formed in the second panel by displacement of the female tabs of the second locking mechanism such that the male and female tabs of the first and second locking mechanism are disposed in the void between the at least four apertures.

10. A package according to claim 9 wherein fold lines between the male tabs of the first locking mechanism and the first panel are arranged to be substantially perpendicular to fold lines between male tabs of the second locking mechanism and the first panel.

11. A package according to claim 9 wherein fold lines between the female tabs of the first locking mechanism and the second panel are arranged to be substantially perpendicular to fold lines between the female tabs of the second locking mechanism and the second panel.

12. A package according to claim 9 wherein the male tabs of the first and second locking mechanism are each coupled to the first panel by a fold line, and each of the first fold lines is orientated at an angle to a free edge of the first panel.

13. A package according to claim 9 wherein the female tabs of the first and second locking mechanism are each coupled to the second panel by a second fold line, each of the second fold lines is orientated at an angle to a free edge of the second panel.

14. A package according to claim 12 wherein the angle between each first fold line and the free edge of the first panel is approximately 45°.

15. A package according to claim 13 wherein the angle between each second fold lines and the free edge of the second panel is approximately 45°.

16. A package according to claim 9 wherein the articles are generally cylindrical.

17. A package according to claim 9 wherein the articles are generally circular in cross section at one end adjacent to the first and second panels.
